(19) United States
(12) Patent Application Publication
(10) Pub. No.: US 2024/0269892 A1
(43) Pub. Date: Aug. 15, 2024

(54) PROCESSING APPARATUS AND ELECTRONIC COMPONENT MANUFACTURING METHOD

(71) Applicant: TDK CORPORATION, Tokyo (JP)

(72) Inventors: Atsuhiro NONAKA, Tokyo (JP); Takashi HORAI, Tokyo (JP); Tomoko KITAMURA, Tokyo (JP)

(73) Assignee: TDK CORPORATION, Tokyo (JP)

(21) Appl. No.: 18/438,904

(22) Filed: Feb. 12, 2024

(30) Foreign Application Priority Data
Feb. 13, 2023 (JP) 2023-020054

(51) Int. Cl. B28D 5/00; G05B 13/02

(52) U.S. Cl. CPC B28D 5/0064; G05B 13/0265

(57) ABSTRACT

A processing apparatus includes a rotatable blade, a blade driving shaft, a table, a position driving mechanism, a first sensor, a second sensor, a start/stop point information extraction section, a characteristic-vibration-information extraction section, and a characteristic-vibration-information extraction section. The shaft drives the blade. The table places a workpiece to be processed. The mechanism changes a relative position between the blade and the workpiece. The first sensor detects a vibration generated by driving the blade. The second sensor detects a vibration generated by driving the blade. The start/stop point information extraction section extracts at least one of a start point information regarding a contact start point and a stop point information regarding a contact stop point based on a detection result of the second sensor. The characteristic-vibration-information extraction section extracts a characteristic vibration information regarding a predetermined characteristic vibration and determines a position of the characteristic vibration.

### BACKGROUND OF THE INVENTION

The present invention is related to a processing apparatus and an electronic component manufacturing method using the processing apparatus.

For example, there is a known technique for processing wafers, substrates, etc., which are raw materials for electronic components, by cutting them into individual pieces using a rotatable blade. In cutting by conventional processing apparatuses, chipping (including cracking) may occur in processing marks (kerfs) such as cutting marks. Possible reasons for this include unsuitable cutting conditions, wear of the grindstone, variations in the quality of raw materials, and the like.

In processing apparatuses, possible methods for detecting chipping generated during processing include a method of photographing the wafer, etc. after cutting and analyzing the image data. During processing, however, cutting water, etc. is sprayed onto the wafer, etc. during processing. Thus, this method has a problem with difficulty in real-time detection, leading to a decrease in production efficiency (see Patent Document 1, etc.).

Meanwhile, as a method for detecting chipping, etc. generated during processing in real time, there is a proposed method of detecting and analyzing vibrations during processing. Extracting characteristic vibrations at the time of generation of chipping makes it is possible to remove the influence of cutting water, etc. and to detect chipping, etc. in real time (see Patent Document 2, etc.).

In the conventional techniques for detecting chipping by detecting vibrations during processing, however, there is the following problem: even if a characteristic vibration can be detected at the time of generation of chipping from vibration data, insufficient is the accuracy of position determination for determining the position on the wafer where the rotatable blade is just in contact with at the time of generation of the vibration. Possible reasons for this include changes in the wear state of the blade, differences in the positional relation between the wafer and the table for placing the wafer depending on the wafer to be processed, and the like. Therefore, only relative position information between the table to which the wafer is fixed and a blade driving shaft is insufficient for the accuracy of position determination.
Patent Document 1: JP2015205388 (A)
Patent Document 2: JP2019206074 (A)

### BRIEF SUMMARY OF THE INVENTION

The present invention has been achieved under such circumstances. It is an object of the invention to provide a processing apparatus, etc. that detects a characteristic vibration for chipping, etc. leading to defects and can precisely determine the position on a wafer where a rotatable blade is in contact with at the time of generation of the vibration.

To achieve the above object, a processing apparatus according to the present invention comprises:
a rotatable blade;
a blade driving shaft for driving the rotatable blade;
a table for placing a workpiece to be processed;
a position driving mechanism for changing a relative position between the rotatable blade and the workpiece;
a first sensor for detecting a vibration generated by driving the rotatable blade;
a second sensor for detecting a vibration generated by driving the rotatable blade, the second sensor being different from the first sensor in at least one of detection method, installation position, and measurement frequency;
a start/stop point information extraction section for extracting at least one of a start point information regarding a contact start point where the rotatable blade starts contacting with the workpiece and a stop point information regarding a contact stop point where the rotatable blade stops contacting with the workpiece based on a detection result of the second sensor; and
a characteristic-vibration-information extraction section for extracting a characteristic vibration information regarding a predetermined characteristic vibration generated while processing the workpiece by the rotary blade and for determining a position of the characteristic vibration generated on the workpiece, based on at least one of the start point information and the stop point information and a detection result of the first sensor.

The processing apparatus according to the present invention includes a first sensor and a second sensor for detecting vibrations generated by driving a rotatable blade, and the second sensor is different from the first sensor in at least one of detection method, installation position, and measurement frequency. The present inventors have found the following problem: in a conventional processing apparatus including one sensor for detecting vibrations, if detection method, installation position, measurement frequency, and the like of the sensor are optimized so that a characteristic vibration can be detected at the time of generation of chipping, etc., it is difficult for the sensor to precisely extract a start point information and a stop point information. Moreover, the present inventors have found the following problem: a start point information and a stop point information can be detected precisely by a second sensor that detects vibrations but differs from the first sensor in at least one of detection method, installation position, and measurement frequency. The processing apparatus according to the present invention can precisely determine the position of the characteristic vibration extracted from the detection result of the first sensor and generated on the workpiece.

For example, the second sensor may comprise an AE sensor.

The detection method of the second sensor is not limited, but when the second sensor is an AE sensor, the start point information and the stop point information can be detected precisely.

For example, the second sensor may be provided on the table.

When the second sensor is provided on the table, vibrations from differences between contact and non-contact between the rotatable blade and the workpiece can be detected effectively near the generation source.

For example, the first sensor may comprise an acceleration sensor.

The detection method of the first sensor is not limited, but when the first sensor is, for example, an acceleration sensor, a predetermined characteristic vibration generated by chipping, etc. can be detected precisely.

For example, the first sensor may be provided on the blade driving shaft or a blade supporter for supporting the blade driving shaft.

When the first sensor is provided on the blade driving shaft or the blade supporter, it is possible to precisely detect a predetermined characteristic vibration generated by chipping, etc. and strongly transmitted to the blade.

The processing apparatus according to the present invention may comprise:
an imaging section for capturing an image of a processing mark made by the rotatable blade on the workpiece and acquiring a processing-mark image data; and
a machine learning section for determining the detection result of the first sensor at the time of generation of a predetermined shape feature in the processing mark of the workpiece after processing, using the detection result of the first sensor, the processing-mark image data, and at least one of the start point information and the stop point information and for learning the characteristic vibration information with the detection result of the first sensor at the time of generation of the shape feature as being one of the characteristic vibrations.

In such a processing apparatus, the start point information and the stop point information can be detected precisely by the second sensor, and it is thus possible to precisely align the positions of the processing mark data and the detection result of the first sensor. Thus, it is possible to effectively learn the relation between a predetermined shape feature, such as chipping, in processing marks and the detection result of the first sensor at the time of generation of the shape feature.

An electronic component manufacturing method according to the first aspect of the present invention comprises the steps of:
preparing the workpiece;
processing the workpiece by any of the processing apparatus mentioned above;
enabling the characteristic-vibration-information extraction section to extract the characteristic vibration and to determine a position of the characteristic vibration generated on the workpiece; and
removing a portion of the workpiece after processing including a position corresponding to the characteristic vibration.

In such an electronic component manufacturing method, it is possible to efficiently remove the workpiece after processing with chipping, etc. and to achieve improvement in nondefective rate and production efficiency.

An electronic component manufacturing method according to the second aspect of the present invention comprises the steps of:
preparing a preliminary workpiece corresponding to the workpiece used for machine learning;
processing the preliminary workpiece by the processing apparatus including the imaging section;
enabling the machine learning section to determine the detection result of the first sensor at the time of generation of a predetermined shape feature in a processing mark of the preliminary workpiece after processing and to learn the characteristic vibration information with the detection result of the first sensor at the time of generation of the shape feature as being one of the characteristic vibrations;
preparing a workpiece different from the preliminary workpiece;
processing the workpiece by the processing apparatus;
enabling the characteristic-vibration-information extraction section to extract the characteristic vibrations and to determine a position of the characteristic vibrations generated on the workpiece; and
removing a portion of the workpiece after processing including a position corresponding to the characteristic vibrations.

In such an electronic component manufacturing method, the detection accuracy for the position of chipping, etc. generated on the workpiece is improved effectively by the position accuracy of the shape feature and the machine learning, the workpiece after processing with chipping, etc. generated in the main processing is removed efficiently, and it is possible to achieve improvement in nondefective rate and production efficiency.

### BRIEF DESCRIPTION OF THE SEVERAL VIEWS OF THE DRAWING

FIG. 1 is a front view of a cutting device as a processing apparatus according to an embodiment of the present invention;

FIG. 2 is a side view of the processing apparatus shown in FIG. 1;

FIG. 3 is a block diagram illustrating an information processing section of the processing apparatus;

FIG. 4 is a schematic view describing an arrangement of first and second sensors in the processing apparatus shown in FIG. 1 and FIG. 2;

FIG. 5 is a conceptual diagram illustrating a correspondence between a detection result of the second sensor and a cutting position of a wafer in the processing apparatus shown in FIG. 1, etc.;

FIG. 6A and FIG. 6B are schematic views comparing the detection result of the first sensor and the detection result of the second sensor shown in FIG. 4;

FIG. 7 is a conceptual diagram illustrating a cutting path of a wafer by the processing apparatus;

FIG. 8 is a block diagram illustrating an information processing section of a processing apparatus according to Second Embodiment;

FIG. 9A to FIG. 9D are conceptual diagrams illustrating data processing in a machine learning section;

FIG. 10 is a conceptual diagram illustrating an example of window processing performed by a characteristic vibration analysis section in the machine learning section;

FIG. 11 is a conceptual diagram illustrating a calculation process for extracting a shape feature of a waveform from the window-processed data as shown in FIG. 10; and

FIG. 12 is a conceptual diagram illustrating another example of window processing and generation processing of vibration change data performed by a characteristic vibration analysis section in the machine learning section.

### DETAILED DESCRIPTION OF THE INVENTION

Hereinafter, the present invention is described based on embodiments shown in the figures.

### First Embodiment

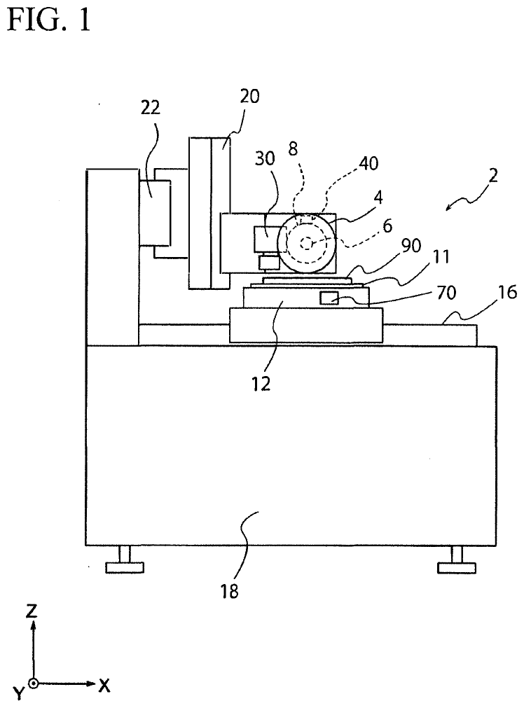

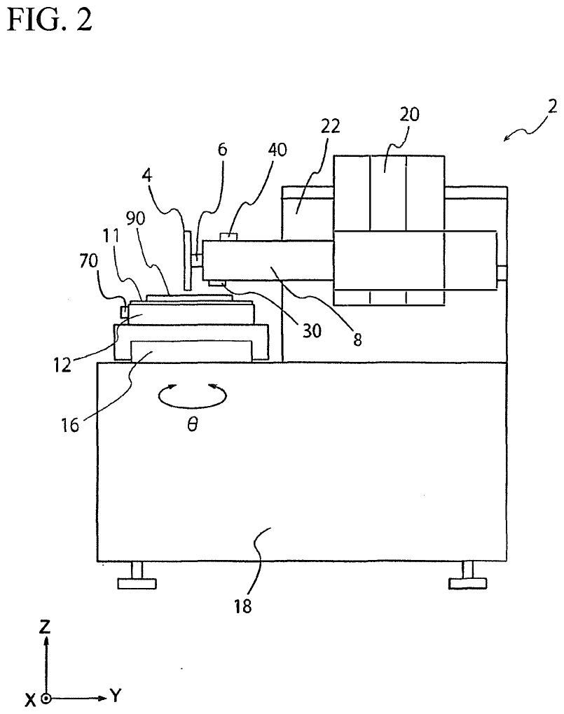

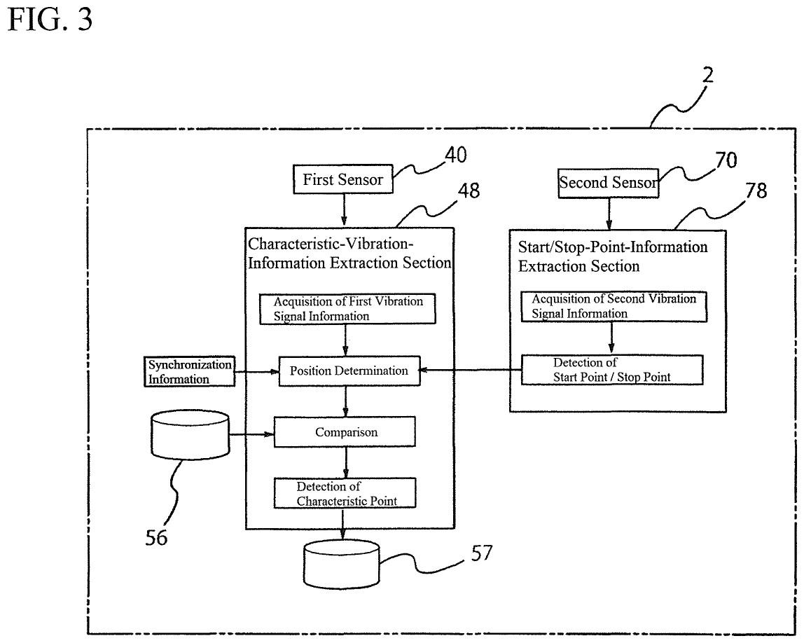

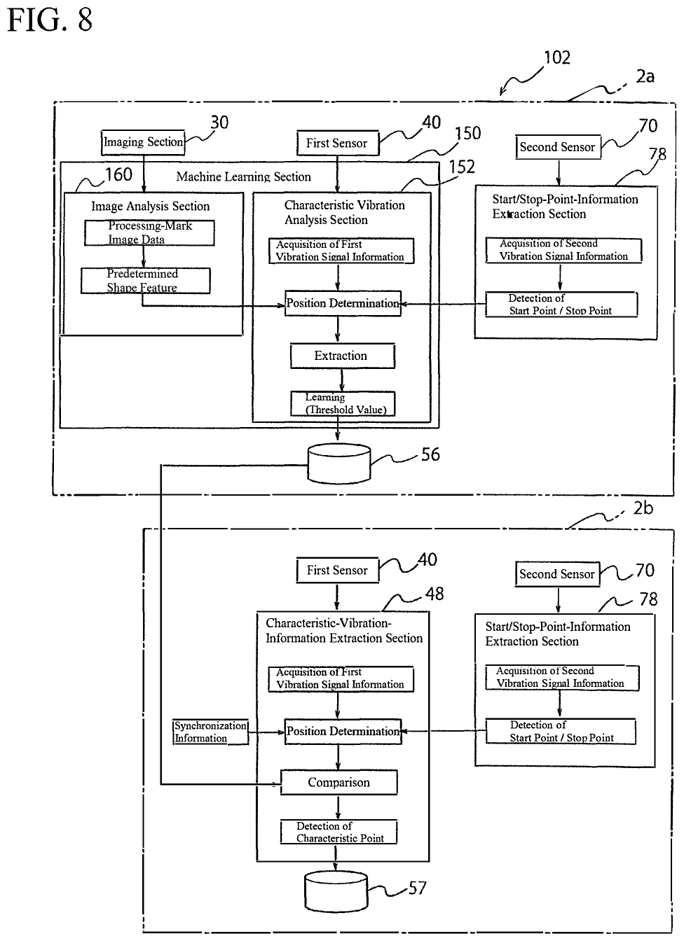

FIG. 1 and FIG. 2 are a front view and a side view of a processing apparatus 2 according to an embodiment of the present invention, and FIG. 3 is a block diagram illustrating an information processing section of the processing apparatus 2. Note that, as described below with FIG. 3, etc., the processing apparatus 2 according to First Embodiment does not employ a camera 30 as an imaging section included in the processing apparatus 2 or a processing mark image data acquired by the camera 30, so the camera 30 is not necessarily required in the processing apparatus 2. However, the processing apparatus 2 may include the camera 30 for capturing an image of a processing mark on a workpiece 90 (this is described in a processing apparatus 102 according to Second Embodiment with FIG. 8 etc.), a camera for position detection of the workpiece 90 on a table 12, and the like.

The processing apparatus 2 includes a rotatable blade 4 as a processing tool. As described below, the rotatable blade 4 is a processing tool that relatively moves to the workpiece 90 by a position movement mechanism, contacts with the workpiece 90, and cuts the workpiece 90 and may be a grindstone. However, the rotatable blade 4 is not limited to only one that cuts the workpiece 90. The rotatable blade 4 of the processing apparatus 2 also includes one that grinds or polishes the workpiece 90.

The processing apparatus 2 includes a blade driving shaft 6. The center of the rotatable blade 4 is fixed to the blade driving shaft 6 for driving the rotatable blade 4, and the rotatable blade 4 is rotatable around the Y-axis by the blade driving shaft 6. The blade driving shaft 6 is held by a blade supporter 8. The blade supporter 8 is held movably in the Z-axis direction by a Z-axis rail 20 as a Z-axis movement mechanism.

The processing apparatus 2 includes a position drive mechanism for changing the relative position between the rotatable blade 4 and the workpiece 90, and the position drive mechanism mainly consists of the Z-axis rail 20 as a Z-axis drive mechanism, a Y-axis rail 22 as a Y-axis drive mechanism, and an X-axis rail 16 as an X-axis drive mechanism.

As shown in FIG. 1, the Z-axis rail 20 is held movably in the Y-axis direction by the Y-axis rail 22 as the Y-axis movement mechanism. The Y-axis rail 22 is fixed to a column extending upward on a fixation base 18. Note that, unlike the processing apparatus 2 shown in FIG. 1 and FIG. 2, in a processing apparatus according to another embodiment, instead of the Z-axis rail 20, the blade supporter 8 may function as a Y-axis movement mechanism for moving the rotatable blade 4 in the Y-axis direction. In such an embodiment, the blade supporter 8 supports the blade driving shaft 6 so that the blade driving shaft 6 is movable along the Y-axis.

The X-axis rail 16, which functions as the X-axis movement mechanism, is disposed and fixed along the X-axis direction on the fixation base 18. The table 12 for placing the workpiece 90 to be processed is disposed on the X-axis rail 16 so as to be movable in the X-axis direction. The workpiece 90 and a tape 11 are arranged detachably on the table 12. The tape 11 is disposed between the workpiece 90 and the table 12 and fixes the workpiece 90 to the table 12 before and after cutting. Note that, as shown in FIG. 2, the upper part of the table 12 may be movable with respect to the lower part of the table 12 around the Z-axis (θ direction). In such a table 12, it is possible to adjust the rotational posture of the workpiece 90 in the θ direction.

For the purpose of detachably holding the workpiece 90 and tape 11, a plurality of vacuum suction holes is formed on the upper surface of the table 12, and the table 12 is capable of suctioning and holding the workpiece 90 and the tape 11 thereon. Note that, the workpiece 90 and the tape 11 may be held detachably on the table 12 using means other than vacuum suction. In the present embodiment, the X-axis, Y-axis, and Z-axis are perpendicular to each other, the Y-axis substantially corresponds with the rotation axis of the rotatable blade 4 (the rotation axis of the blade driving shaft 6), and the Z-axis substantially corresponds with the vertical direction.

In the present embodiment, the X-axis rail 16 holds the table 12 so that the table 12 is movable in the X-axis direction, and the table 12, the tape 11, and the workpiece 90 relatively move in the X-axis direction with respect to the rotatable blade 4 as a processing tool. Also, the Y-axis rail 22 holds the Z-axis rail 20 so that the Z-axis rail 20 is movable in the Y-axis direction, and the blade driving shaft 6 and the rotatable blade 4 held by the Y-axis rail 22 via the Z-axis rail 20 is thereby relatively movable in the Y-axis direction with respect to the workpiece 90 on the table 12. Also, the Z-axis rail 20 holds the blade supporter 8 so that the blade supporter 8 is movable in the Z-axis direction, and the blade driving shaft 6 and the rotatable blade 4 are thereby relatively movable in the Z-axis direction with respect to the workpiece 90 on the table 12.

When the workpiece 90 is processed by the processing apparatus 2, the rotatable blade 4 is rotated around the Y-axis by the blade driving shaft 6. Moreover, the Z-axis rail 20 moves the blade supporter 8 downward in the Z-axis, and the lower end of the rotatable blade 4 is thereby located at the same height as the tape 11 and the workpiece 90 to be cut. Moreover, the table 12 for placing the tape 11 and the workpiece 90 is moved in the X-axis direction by the X-axis rail 16, and the tape 11 and the workpiece 90 thereby come into contact with the blade 4 being rotating and scraped and cut along the X-axis direction.

Note that, the rotatable blade 4 completely cuts the workpiece 90, but the position (height) of the rotatable blade 4 in the Z-axis direction during cutting is adjusted so that the rotatable blade 4 cuts only the upper part of the tape 11 and does not cut the lower part of the tape 11. Thus, the rotatable blade 4 does not directly contact with the table 12 under the tape 11.

As shown in FIG. 1, the processing apparatus 2 includes at least two different vibration detection sensors including a first sensor 40 and a second sensor 70. Both of the first sensor 40 and the second sensor 70 detect vibrations generated by driving the rotatable blade 4. The vibrations generated by driving the rotatable blade 4 include vibrations generated by processing and cutting the tape 11 and the workpiece 90 by the drive of the rotatable blade 4, vibrations before and after the rotatable blade 4 contacts with the workpiece 90 and the tape 11, and the like. Here, the vibrations before and after the contact include vibrations generated by the impact immediately after the rotatable blade 4 contacts with the workpiece 90 or the tape 11 and vibrations generated by the impact immediately after the rotatable blade 4 separates from the workpiece 90 or the tape 11.

The first sensor 40 is provided on the blade driving shaft 6 or the blade supporter 8 supporting the blade driving shaft 6. If an irregular processing, such as chipping, is generated during processing, the first sensor 40 is preferably provided near the rotatable blade 4 and the blade driving shaft 6 in the processing apparatus 2, from the viewpoint of appropriately detecting characteristic vibrations generated during the irregular processing. However, the installation position of the first sensor 40 is not limited to only the position shown in FIG. 1 and FIG. 2 and may be provided at a position different from that of the blade driving shaft 6 and the blade supporter 8.

The detection method of the first sensor 40 is not limited, but the first sensor 40 is preferably, for example, an acceleration sensor from the viewpoint of appropriately detecting characteristic vibrations generated during irregular processing. Also, the maximum measurement frequency of the first sensor 40 is not limited, but is preferably, for example, 1 to 300 kHz and is more preferably, for example, 10 to 100 kHz, from the viewpoint of appropriately detecting characteristic vibrations.

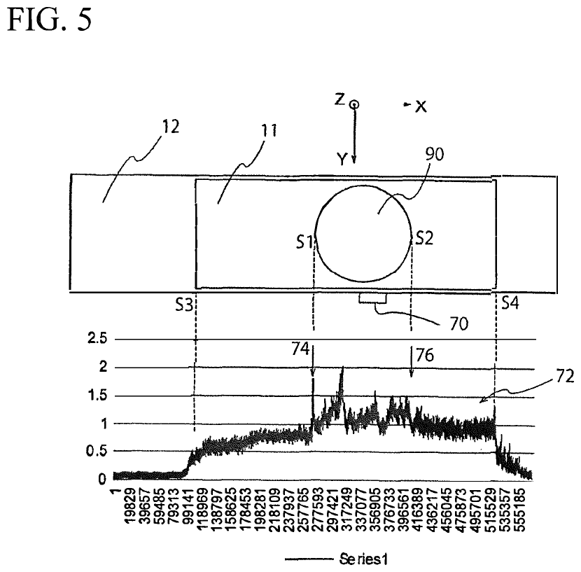

As with the first sensor 40, the second sensor 70 detects vibrations generated by driving the rotatable blade 4, but is different from the first sensor 40 in terms of at least one of detection method, installation position, and measurement frequency. The second sensor 70 included in the processing apparatus 2 is provided on the table 12. As described below, the second sensor 70 is preferably disposed near the workpiece 90 in the processing apparatus 2 from the viewpoint of favorably extracting contact start point information, etc. regarding a contact start point S1 (see FIG. 5) where the rotatable blade 4 starts contacting with the workpiece 90 from the result. However, the installation position of the second sensor 70 is not limited to only the position shown in FIG. 1 and FIG. 2 and may be provided at a position different from that of the table 12.

The detection method of the second sensor 70 is not limited, but from the viewpoint of appropriately detecting a contact start point S1 and a contact stop point S2 described below, the second sensor 70 is preferably, for example, an AE sensor using a piezoelectric element or the like. The measurement frequency of the second sensor 70 is not limited, but is preferably, for example, 60 to 300 kHz and is more preferably, for example, 80 to 150 kHz, from the viewpoint of appropriately detecting characteristic vibrations.

As can be understood from FIG. 3, which illustrates an information processing section of the processing apparatus 2, the processing apparatus 2 includes a characteristic-vibration-information extraction section 48. The characteristic-vibration-information extraction section 48 detects characteristic vibrations generated at the time of irregular processing based on the detection result of the first sensor 40, or the like. Moreover, the processing apparatus 10 includes a start/stop-point-information extraction section 78. The start/stop-point-information extraction section 78 extracts at least one of a start point information regarding a contact start point S1 where the rotatable blade 4 starts contacting with the workpiece 90 and a contact stop point S2 where the rotatable blade 4 stops contacting with the workpiece 90 (see FIG. 5) based on the detection result of the second sensor 70, or the like.

The characteristic-vibration-information extraction section 48 shown in FIG. 3 extracts a characteristic vibration information regarding predetermined characteristic vibrations generated during processing of the workpiece 90 by the rotatable blade 4 and determines the position of the predetermined characteristic vibrations generated on the workpiece 90 based on the detection result of the first sensor 40 and at least one of the start point information and the stop point information extracted by the start/stop-point-information extraction section 78. Here, the predetermined characteristic vibrations extracted as the characteristic vibration information include characteristic vibrations generated at the time of irregular processing, such as characteristic vibrations generated at the time of generation of chipping in the workpiece 90 and characteristic vibrations generated at the time of generation of cracking in the workpiece 90.

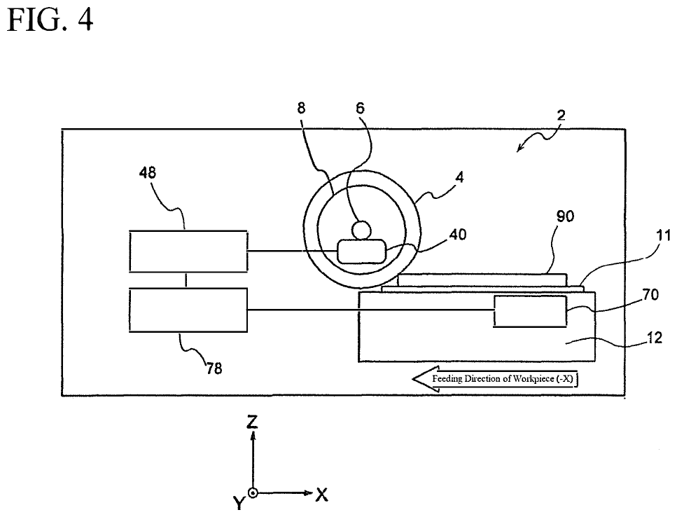

In the processing apparatus 2, if processing defects, such as chipping, are generated during processing of the workpiece 90, the position of the processing defects generated on the workpiece 90 can be determined with high accuracy by cooperating the first sensor 40, the second sensor 70, the characteristic-vibration-information extraction section 48, the start/stop-point-information extraction section 78, and the like shown in FIG. 3. FIG. 4 is a conceptual diagram schematically illustrating the vicinity of the installation positions of the first sensor 40 and the second sensor 70 in the processing apparatus 2, the output destinations of the detection results of the first sensor 40 and the second sensor 70, and the like.

As shown in FIG. 4, in the processing apparatus 2, the table 12 on which the workpiece 90 and the tape 11 are placed move from the positive side to the negative side of the rotatable blade 4 in the X-axis direction with respect to the rotatable blade 4 rotationally driven with the blade support 8 stopped. As a result, the workpiece 90 and the tape 11 move from the position of the rotatable blade 4 on the positive side in the X-axis direction before cutting to the position of the rotatable blade 4 on the negative side in the X-axis direction after cutting via the position under the rotatable blade 4.

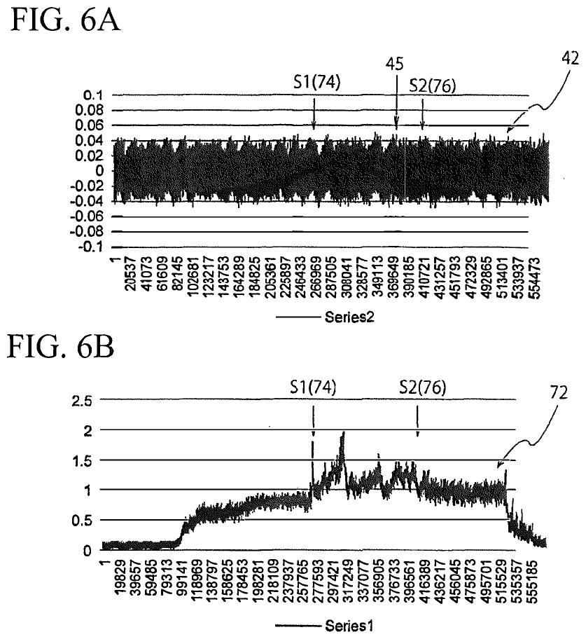

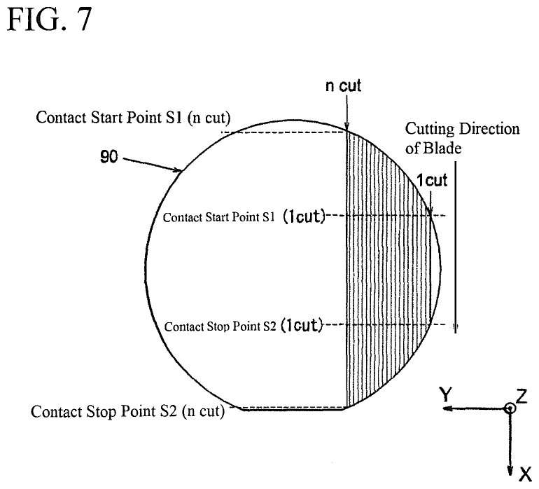

FIG. 7 schematically illustrates a cutting position (cutting line) of the workpiece 90 by the processing apparatus 2. As shown in FIG. 7, the workpiece 90 is often cut not only once but multiple times (n times in FIG. 7). Such a cutting is performed in the processing apparatus 2 by, for example, combining the reciprocating movement of the table 12 in the X-axis direction shown in FIG. 6A and FIG. 6B, the reciprocating movement of the rotatable blade 4 in the Z-axis direction, and the movement of the rotatable blade 4 in the Y-axis direction. Note that, as shown in FIG. 7, when the workpiece 90 is circular, the position of the workpiece 90 in the X-axis direction, the cut length, etc. differ depending on each cut.

Here, in the cutting of the workpiece 90 by the processing apparatus 2, it is difficult to determine the position on the workpiece 90 where the characteristic vibrations are generated during processing of the workpiece 90 by the rotatable blade 4 based only on the detection result of the first sensor 40. Reasons for this include difference in the positional relation between a wafer and the table for placing the wafer depending on the wafer to be processed, minute positional deviations during processing, and the like. Also, there is a reason for this that when the workpiece 90 is circular as shown in FIG. 7, the cutting length changes for each cut, so a slight positional deviation due to wear or vibration adds up to other errors, which can easily lead to large errors.

Moreover, the inventors have also attempted to extract not only characteristic vibration information, but also start point information, stop point information, etc. from the detection result by the first sensor 40. As shown in FIG. 6A, however, the detection result of the first sensor 40 is optimized for extracting characteristic vibration information associated with processing defects generated during processing of the workpiece 90 and is thus not necessarily suitable for extraction of start point information and stop point information different from them in mode, and an analysis result was obtained that it is difficult to extract start point information and stop point information from the detection result of the first sensor 40. Also, the detection result of the first sensor 40 is required to be suitable as source data for advanced and multifaceted information analysis such as frequency processing, statistical processing, and machine learning utilizing these analysis results in combination. As the source data for obtaining start point information and stop point information, however, it is required to accurately obtain information with a simpler analysis method, and it is thereby found that it is difficult to obtain both data with different required characteristics from a detection result of one sensor.

Thus, the processing apparatus 2 includes the first sensor 40 and the second sensor 70, which are two different vibration detection sensors, and can overcome the above-mentioned problem by differently using the detection result of the first sensor 40 and the detection result of the second sensor 70. Hereinafter, an example of extraction of characteristic vibration information by the processing apparatus 2 and determination of its position on the workpiece 90 is described in detail mainly using FIG. 3 to FIG. 6B.

The processing of the workpiece 90 by the processing apparatus 2 shown in FIG. 1 and FIG. 2 is performed by preparing the workpiece 90 and thereafter arranging the tape 11 and the workpiece 90 on the table 12. As shown in FIG. 3, the detection results of the first sensor 40 and the second sensor 70 in the processing apparatus 2 are transmitted to the characteristic-vibration-information extraction section 48 and the start/stop-point-information extraction section 78, respectively. As shown in FIG. 4, the characteristic-vibration-information extraction section 48 and the start/stop-point-information extraction section 78 may be provided on the fixation base 18 or the like in the processing apparatus 2, and this may be achieved by a computer system, etc. connects to the fixation base 18, etc. via a network, etc.

Note that, the information processing section of the processing apparatus 2 including the characteristic-vibration-information extraction section 48 and the start/stop-point-information extraction section 78 shown in FIG. 3 is achieved by a computer system including microprocessor, storage device, display device, input device, and the like. The computer system achieving the information processing section of the processing apparatus 2 may be either an on-premise type or a cloud type or may be a hybrid of an on-premise type and a cloud type.

As shown in FIG. 4, the detection results of the first sensor 40 and the second sensor 70 at the time of processing the workpiece 90 are transmitted in real time to the characteristic-vibration-information extraction section 48 and the start/stop-point-information extraction section 78. The processing apparatus 2 according to the present embodiment is described with an example in which detection results of the first sensor 40 and the second sensor 70 are transmitted in real time to the characteristic-vibration-information extraction section 48 and the start/stop-point-information extraction section 78. However, the processing apparatus 2 is not limited to this and may be, for example, one in which the detection results of the first sensor 40 and the second sensor 70 are once stored in a storage device and input to the characteristic-vibration-information extraction section 48 and the start/stop-point-information extraction section 78.

The second sensor 70 shown on the right side of FIG. 3 starts detecting vibrations generated by driving the rotatable blade 4 at any time before the first cut (1 cut) of the workpiece 90 shown in FIG. 7 starts. Also, the second sensor 70 stops detecting vibrations generated by driving the rotatable blade 4 at any point after the last cut (n cut) of the workpiece 90 is completed. The second sensor 70 may continuously detect vibrations from before the start of the first cut to after the end of the last cut and may temporarily stop detecting vibrations, for example, when the rotatable blade 4 is raised in the Z-axis direction and has no possibility of contacting with the workpiece 90. Preferably, however, the second sensor 70 continuously detects vibrations in each cut at least from immediately before the rotatable blade 4 contacts with the workpiece 90 to immediately after the cutting is finished and the contact between the rotatable blade 4 and the workpiece 90 is stopped.

As shown in FIG. 3, the detection result acquired by the second sensor 70 during processing is transmitted to the start/stop-point-information extraction section 78, and the start/stop-point-information extraction section 78 acquires a second vibration signal information 72 as a detection result of the second sensor 70. Moreover, the start/stop-point-information extraction section 78 extracts a start point information 74 regarding the contact start point S1 where the rotatable blade 4 starts contacting with the workpiece 90 and a stop point information 76 regarding the contact stop point S2 where the rotatable blade 4 stops contacting with the workpiece 90 based on the second vibration signal information 72 (see FIG. 5).

FIG. 5 is a conceptual diagram in which an example of the second vibration signal information 72 acquired by the second sensor 70 when the workpiece 90 is cut along a cutting line passing through its center is illustrated corresponding to the cutting position where the second vibration signal information 72 is acquired. It can be seen from FIG. 5 that the second vibration signal information 72 from the second sensor 70 changes at the time where the rotatable blade 4 starts contacting with the tape 11 (tape contact start point S3) and at the time where the rotatable blade 4 separates from the tape 11 (tape contact stop point S4).

Moreover, the second vibration signal information 72 from the second sensor 70 shows a clear peak different from other parts at the contact start point S1 where the rotatable blade 4 starts contacting with the workpiece 90, and the start/stop-point-information extraction section 78 extracts the position of this peak (at the time of generation) as being the start point information 74. It can also be seen from FIG. 5 that the second vibration signal information 72 from the second sensor 70 changes even at the contact stop point S2 where the rotatable blade 4 stops contacting with the workpiece 90, although it is not as clear as the contact start point S1. The start/stop-point-information extraction section 78 can extract the position of a waveform characteristically appearing at the contact stop point S2 as being the stop point information 76. In the example shown in FIG. 5, however, since a particularly steep characteristic waveform appears at the contact start point S1, the start/stop-point-information extraction section 78 may extract only the start point information 74 among the start point information 74 and the stop point information 76.

As shown in FIG. 3, the start/stop-point-information extraction section 78 transmits the start point information 74 extracted, etc. to the characteristic-vibration-information extraction section 48. Meanwhile, the detection result acquired by the first sensor 40 during processing is transmitted to the characteristic-vibration-information extraction section 48, and the characteristic-vibration-information extraction section 48 acquires the first vibration signal information 42 as the detection result of the first sensor 40. Note that, in the acquisition of the first vibration signal information 42 by the first sensor 40, similarly to the acquisition of the second vibration signal information 72 by the second sensor 70 shown in FIG. 5, the vibrations generated by driving the rotatable blade 4 is detected from any point before the first cut (1 cut) of the workpiece 90 starts to any point after the last cut (n cut) of the workpiece 90 is completed.

FIG. 6A and FIG. 6B are conceptual diagrams in which an example of the first vibration signal information 42 (FIG. 6A) acquired by the first sensor 40 and the second vibration signal information 72 (FIG. 6B) corresponding therewith are displayed with their time axes aligned. Note that, the second vibration signal information 72 shown in FIG. 6B is similar to that shown in FIG. 5. Unlike the second vibration signal information 72 shown in FIG. 6B, the first vibration signal information 42 shown in FIG. 6A does not show any clear changes that can be recognized by visually observing the data at the contact start point S1 where the rotatable blade 4 starts contacting with the workpiece 90 or the contact stop point S2 where the rotatable blade 4 stops contacting with the workpiece 90.

Then, the characteristic-vibration-information extraction section 48 shown in FIG. 3 determines at least one of the contact start point S1 and the contact stop point S2 in the first vibration signal information 42 using at least one of the start point information 74 and the stop point information 76 extracted by the start/stop-point-information extraction section 78 (“position determination” in FIG. 3). For example, the characteristic-vibration-information extraction section 48 can positionally determine the position on the first vibration signal information 42 that is the same time as where the contact start point S1 is extracted in the second vibration signal information 72 as being the contact start point S1 in the first vibration signal information 42 using synchronization information between the first vibration signal information 42, the start point information 74, the first sensor 40, and the second sensor 70.

The characteristic-vibration-information extraction section 48 determines the contact start point S1 in the first vibration signal information 42 and can thereby accurately determine the position on the workpiece 90 where the rotatable blade 4 is just processing at any measurement point in the first vibration signal information 42 and at the time of acquisition of this measurement point based on feeding rate of the table shown in FIG. 6A and FIG. 6B and the measurement frequency of the first sensor 40. As shown in FIG. 3, the characteristic-vibration-information extraction section 48 determines the correspondence between the measurement point in the first vibration signal information 42 and the position on the workpiece 90 and thereafter extracts a characteristic vibration information (only the position of the characteristic vibration 45 in the first vibration signal information 42 is shown in FIG. 6A and FIG. 6B) regarding predetermined characteristic vibrations 45 generated during processing of the workpiece 90 by the rotatable blade 4 based on the first vibration signal information 42. The predetermined characteristic vibrations 45 to be extracted include, for example, characteristic vibrations, such as chipping, at the time of processing defects that may be generated during processing of the workpiece 90.

The extraction of the characteristic vibration information by the characteristic-vibration-information extraction section 48 can be performed by, for example, comparing the shape features of a waveform generated at the time of chipping, which are stored in a comparison data storage section 56 by the processing apparatus 2, and the shape features of a waveform included in the first vibration signal information 42. Here, the shape features of the waveform include not only the shape features of a waveform acquired by the first sensor 40 as shown in FIG. 6A, but also the shape features of a waveform appearing after performing various processing, such as frequency processing and statistical processing, on the first vibration signal information 42. At this time, the characteristic-vibration-information extraction section 48 reads out the shape features of the waveform serving as the reference for comparison from the comparison data storage section 56, performs analysis processing on the first vibration signal information 42 to be extracted, and calculates the degree of approximation between the waveform serving as the reference for comparison and the waveform extracted from the first vibration signal information 42. Note that, the shape features of the waveform are not limited and can be similar to those extracted by a machine learning section 150 in Second Embodiment described below.

When the characteristic vibration information regarding the predetermined characteristic vibrations 45 is found in the first vibration signal information 42 as a target, the characteristic-vibration-information extraction section 48 shown in FIG. 3 further determines the position of the predetermined characteristic vibrations 45 generated on the workpiece 90. The characteristic vibration information extracted by the characteristic-vibration-information extraction section 48 and the information of the position of the predetermined characteristic vibrations 45 generated on the workpiece 90 are stored in a result storage section 57, such as a non-volatile memory. Note that, in the case of processing the workpiece 90 by the processing apparatus 2 and manufacturing electronic components using the workpiece 90 after processing, if necessary, among the individual pieces of the workpiece 90 after processing, those corresponding to the position of the predetermined characteristic vibrations 45 generated on the workpiece 90 can be removed before being used in the next manufacturing step.

In such a processing apparatus 2, the position of processing defects, such as chipping, generated on the workpiece 90 can be appropriately and accurately detected from vibration information by a plurality of different vibration sensors including the first sensor 40 and the second sensor 70. Moreover, in the processing apparatus 2, the generation of processing defects, such as chipping, can be accurately detected from vibration information including acoustic vibrations without visual confirmation with a microscope image of the workpiece 90, and it is thus possible to reduce the defective rate in last products with high production efficiency. Note that, as shown in FIG. 3, the characteristic-vibration-information extraction section 48 of the processing apparatus 2 determines the position of the start point before extracting the characteristic vibration information from the first vibration signal information 42 of the first sensor 40, but unlike this, after the characteristic vibration information is extracted from the first vibration signal information 42, the position of the characteristic vibration information extracted on the workpiece 90 may be determined based on the start point information extracted from the second vibration signal information 72.

### Second Embodiment

FIG. 8 is a block diagram illustrating an information processing section of a processing apparatus 102 according to Second Embodiment. The configurations of the processing apparatus 102 other than the information processing section are the same as those of the processing apparatus 2 according to First Embodiment. That is, the processing apparatus 102 includes a machining section including a rotatable blade 4, a table 12, and the like similar to those of the processing apparatus 2 shown in FIG. 1 and FIG. 2 and also includes an information processing section including a preliminary processing section 2a and a main processing section 2b as shown in FIG. 8.

The preliminary processing section 2a of the processing apparatus 102 includes a machine learning section 150. The machine learning section 150 learns the correspondence between the detection result of the first sensor 40 and processing defects, such as chipping, generated on the workpiece 90. Also, the machine learning section 150 includes an image analysis section 160 and a characteristic vibration analysis section 152. The image analysis section 160 analyzes image data of the workpiece 90 captured by a camera 30 as an imaging section. The characteristic vibration analysis section 152 analyzes the detection result of the first sensor 40. Note that, the main processing section 2b in the processing apparatus 102 is similar to the information processing section of the processing apparatus 2 shown in FIG. 3.

The processing apparatus 102 processes a preliminary workpiece used for machine learning, processes information acquired by processing the preliminary workpiece in the preliminary processing section 2a, acquires comparison data for extracting processing defects, such as chipping, from the detection result of the first sensor 40, and stores the comparison data in the comparison data storage section 56. Moreover, the processing apparatus 102 prepares the workpiece 90 for main processing and can perform processing and detection of processing defects of the workpiece 90 as described in First Embodiment using the comparison data acquired and updated in the preliminary processing.

Note that, in the processing apparatus 102, the machining portions of the rotatable blade 4 and the table 12 used for processing of the preliminary workpiece may be the same as (same device) or different from the machining portions of the rotatable blade 4 and the table 12 used for the workpiece 90 for main processing. The preliminary workpiece used for machine learning may be the same one (same material and shape) as the workpiece 90 for main processing or may be a workpiece prepared for learning different from the workpiece 90 for main processing.

Note that, the processing apparatus 102 is described focusing on the differences from the processing apparatus 2 according to First Embodiment, and the common matters with the processing apparatus 2, such as the main processing section 2b shown in FIG. 8, are not described.

For example, as shown in FIG. 1, the camera 30 of the processing apparatus 102 is attached to the blade supporter 8 and is capable of capturing images of processing marks formed on the workpiece 90 as a result of processing the workpiece 90 by the rotatable blade 4 after the processing or in real time if possible. As shown in FIG. 8, processing mark image data, which is primary data of processing marks captured by the camera 30, is transmitted to the image analysis section 160 in the machine learning section 150.

Meanwhile, in the processing apparatus 102, a first vibration signal information 42, which is a detection result of the first sensor 40, is input to the characteristic vibration analysis section 152 of the machine learning section 150 shown in FIG. 8. The processing of the first vibration signal information 42 in the machine learning section 150 is different from the above-described processing in the characteristic-vibration-information extraction section 48. The processing in the machine learning section 150 is described in detail below.

Meanwhile, a second vibration signal information 72, which is a detection result of the second sensor 70, is input to a start/stop-point-information extraction section 78 similar to that of the processing apparatus 2, and in the start/stop-point-information extraction section 78, processing similar to that performed in the processing apparatus 2 is performed on the second vibration signal information 72. That is, the start/stop-point-information extraction section 78 extracts at least one of the start point information 74 and the stop point information 76 from the second vibration signal information 72 and outputs it to the machine learning section 150.

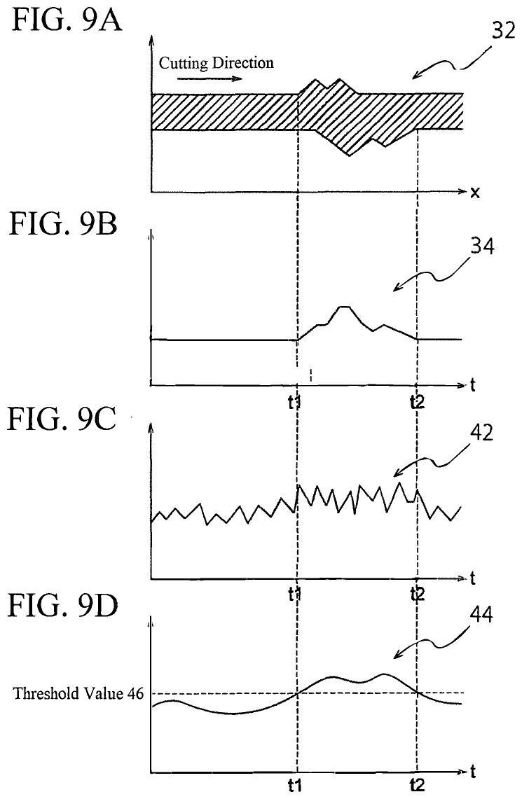

FIG. 9A to FIG. 9D are conceptual diagrams showing data processing in the machine learning section 150. In particular, FIG. 9A and FIG. 9B are conceptual diagrams showing image analysis processing of processing-mark image data performed in the image analysis section 160 of the machine learning section 150. FIG. 9A is a conceptual diagram showing an example of a processing-mark image data 32 transmitted from the camera 30 to the image analysis section 160. As shown in FIG. 9A, the processing-mark image data 32 includes images of processing marks along the cutting direction (processing direction) of the workpiece 90.

For example, the image analysis section 160 shown in FIG. 8 can produce secondary data from the processing-mark image data 32 (FIG. 9A), which is primary data captured by the camera 30, by performing image analysis on the processing-mark image data 32. For example, the image analysis section 160 produces a processing-mark change data 34 related to the time change of the processing marks shown in FIG. 9B from the processing-mark image data 32 shown in FIG. 9A. The processing-mark change data 34 is data showing the relation between the cutting width substantially perpendicular to the cutting direction (vertical axis) and the time course of cutting (horizontal axis; converted from the position change in the cutting direction). FIG. 9B shows the processing-mark change data 34 as a graph.

As can be understood from the comparison between FIG. 9A and FIG. 9B, the position where the cutting width changes and the magnitude of the change can be extracted as numerical data from the processing-mark change data 34. In the image analysis section 160, for example, a portion where the cutting width changes significantly beyond a predetermined value as shown in the center of FIG. 9B can be extracted as a predetermined shape feature of the processing marks formed on the workpiece 90. A representative example of the predetermined shape feature generated in the processing of the workpiece 90 by the processing apparatus 102 includes processing defects, such as chipping, of the cut portion of the workpiece 90 by the rotatable blade 4 as a processing tool.

As shown in FIG. 8, the information regarding the predetermined shape feature detected by the image analysis section 160 in the machine learning section 150 is transmitted to the characteristic vibration analysis section 152.

The first vibration signal information 42 (see FIG. 6A), which is the detection result of the first sensor 40, is transmitted to the characteristic vibration analysis section 152 of the machine learning section 150 shown in FIG. 8. Also, at least one of the start point information 74 and the stop point information 76 (see FIG. 5) is transmitted from the start/stop-point-information extraction section 78 to the characteristic vibration analysis section 152. That is, the start point information 74, etc. from the start/stop-point-information extraction section 78, the first vibration signal information 42 from the first sensor 40, and the information regarding the predetermined shape feature of the processing marks detected in the image analysis section 160 are input to the characteristic vibration analysis section 152 of the machine learning section 150.

The characteristic vibration analysis section 152 shown in FIG. 8 determines the first vibration signal information 42 at the time of generation of predetermined shape feature in the processing marks of the preliminary workpiece after processing using at least one of the start point information 74 and the stop point information 76 (see FIG. 6B), the first vibration signal information 42, and the information regarding predetermined shape feature of the processing marks (processing-mark change data 34; see FIG. 9B).

FIG. 9C is a conceptual diagram showing an example of the first vibration signal information 42, which is primary data regarding the detection result of the first sensor 40, and is displayed with the time axes (horizontal axes) aligned with the processing-mark change data 34. In the characteristic vibration analysis section 152 of the machine learning section 150, first, similarly to the characteristic-vibration-information extraction section 48 shown in FIG. 3, at least one of the contact start point S1 and the contact stop point S2 in the first vibration signal information 42 (“position determination” in FIG. 8) is determined using at least one of the start point information 74 and the stop point information 76 extracted in the start/stop-point-information extraction section 78. For example, the characteristic vibration analysis section 152 can positionally determine the position on the first vibration signal information 42 that is the same time as where the contact start point S1 is extracted in the second vibration signal information 72 as being the contact start point S1 in the first vibration signal information 42 using synchronization information between the first vibration signal information 42, the start point information 74, the first sensor 40, and the second sensor 70 (see FIG. 6A and FIG. 6B).

As shown in FIG. 9A to FIG. 9D, the machine learning section 150 can accurately align the horizontal axes (time axes) of the processing-mark change data 34 acquired from the camera 30 and the first vibration signal information 42 acquired from the first sensor 40 by determining the contact start point S1 in the first vibration signal information 42. After that, the characteristic vibration analysis section 152 determines the first vibration signal information 42 (t1 to t2 in FIG. 9C) at the time of generation of predetermined shape feature in the processing marks of the preliminary workpiece after processing.

Moreover, the characteristic vibration analysis section 152 extracts the first vibration signal information 42 (t1 to t2 in FIG. 9C) at the time of generation of predetermined shape feature in the processing-mark change data 34 as being one of characteristic vibrations generated at the time of formation of predetermined shape feature on the processing marks. Moreover, the machine learning section 150 stores information regarding the characteristic vibrations extracted by the characteristic vibration analysis section 152 into the comparison data storage section 56 as characteristic vibration information and can thereby learn the correspondence between processing defects generated on the workpiece 90 and the detection result of the first sensor 40.

Moreover, for example, the characteristic vibration analysis section 152 performs analysis, statistical processing, and the like on the first vibration signal information 42 from the first vibration signal information 42 shown in FIG. 9C detected by the first sensor 40 and can thereby produce, for example, secondary data, such as the vibration change data 44, related to the time change of vibration shown in FIG. 9D.

The vibration change data 44 is obtained by performing a specific signal processing on the first vibration signal information 42, which is primary data of vibration. FIG. 9D is a conceptual diagram showing the vibration change data 44 produced by the characteristic vibration analysis section 152 and is a graph in which the vibration change data 44 is plotted with the vertical axis representing the magnitude of signal and the horizontal axis representing the passage of time. In the vibration change data 44 shown in FIG. 9D, it may be possible to more clearly extract characteristic vibrations corresponding to the predetermined shape feature in the processing marks shown in FIG. 9B than the primary data shown in FIG. 9C.

That is, the characteristic vibration analysis section 152 determines the vibration change data 44 (t1 to t2 in FIG. 9D) at the time of generation of the predetermined shape feature in the processing marks of the preliminary workpiece after processing in the same way as is done for the first vibration signal information 42. Moreover, the characteristic vibration analysis section 152 extracts the vibration change data 44 (t1 to t2 in FIG. 9D) at the time of generation of the predetermined shape feature in the processing-mark change data 34 as being a mark for finding one of the characteristic vibrations generated at the time of formation of the predetermined shape feature in the processing marks. The machine learning section 150 stores information regarding the vibration change data 44 extracted by the characteristic vibration analysis section 152 into the comparison data storage section 56 as characteristic vibration information.

The characteristic vibration analysis section 152 can calculate a threshold value 46 for extracting characteristic vibrations from the vibration change data 44 in the main processing by collecting a plurality of values of the vibration change data 44 obtained at the time of generation of the predetermined shape feature in the processing marks and statistically processing the values. For example, when the vibration change data 44 shown in FIG. 4D is the threshold value 46 or more indicated by a dashed line, the processing apparatus 102 can determine that processing defects such as chipping (processing defects that result in product defects) are generated in the processing of the workpiece 90 by the rotatable blade 4. The machine learning section 150 can also store the threshold value 46 regarding such a vibration change data 44 into the comparison data storage section 56 as being characteristic vibration information.

Accordingly, in the processing apparatus 102, the machine learning section 150 in the preliminary processing section 2a shown in FIG. 8 determines the detection result of the first sensor 40 at the time of generation of processing defects, such as chipping, using the camera 30 and the detection results of the first sensor 40 and the second sensor 70 and learns characteristic vibration information with this detection result as being one of characteristic vibrations generated in the processing defects. The learning result of the machine learning section 150 is stored into the comparison data storage section 56.

Moreover, in the processing apparatus 102, the main processing section 2b shown in FIG. 8 processes the workpiece 90 and extracts defective workpieces generated in the processing in the same manner as in the processing apparatus 2 shown in FIG. 8. In the main processing by the processing apparatus 102, a workpiece 90 different from the workpiece used in the preliminary processing is prepared, and this workpiece 90 is processed by the machining section of the processing apparatus 102 as shown in FIG. 1 and FIG. 2. The characteristic-vibration-information extraction section 48 of the main processing section 2b extracts characteristic vibrations generated at the time of processing defects from the detection result of the first sensor 40 using the information of the comparison data storage section 56 updated by the learning of the machine learning section 150. The characteristic-vibration-information extraction section 48 of the main processing section 2b determines the position of the characteristic vibration extracted on the workpiece 90 and, if necessary, removes a portion including the generated position of the characteristic vibration from the workpiece 90 after processing.

In such a processing apparatus 102, as shown in FIG. 9A to FIG. 9D, time axes (or positions in the processing direction) of the data 32 and 34 from the camera 30 and the data 42 and 44 from the first sensor 40 can be aligned extremely precisely by detecting and using the start point information 74 regarding the contact start point and the stop point information 76 regarding the contact stop point with the second sensor 70 different from the first sensor 40 (see FIG. 5 to FIG. 6B). Thus, it is possible to accurately determine the detection result of the first sensor 40 at the time of generation of processing defects, such as chipping, and to enhance the learning effect by the machine learning section 150.

As described above, the processing apparatus 2 (102) and the electronic component manufacturing method using the processing apparatus 2 (102) according to the present disclosure are described with reference to multiple embodiments, but the technical scope of the present disclosure is not limited to only these embodiments. For example, the characteristic-vibration-information extraction section 48 shown in FIG. 3 and FIG. 8 may perform various processes, such as frequency processing and statistical processing, on the first vibration signal information 42 according to the data read out from the comparison data storage section 56 and extract the characteristic vibration information by comparing the processed data with the data read from the comparison data storage section 56.

In the example shown in FIG. 9A to FIG. 9D, the horizontal axes of the cutting-mark change data 34 acquired by the camera 30 and the first vibration signal information 42 acquired by the first sensor 40 are referred to as time, but the horizontal axis of each data can be replaced with the position along the processing direction (X-axis direction) of the workpiece 90, and calculation processing may be performed with the horizontal axis of each data as being the position along the processing direction. In the characteristic vibration analysis section 152 and the characteristic-vibration-information extraction section 48 of the processing apparatus 2 (102), window processing may be performed on the first vibration signal information 42 for the purpose of effectively performing machine learning in the machine learning section 150 or effectively utilizing the learning result of machine learning.

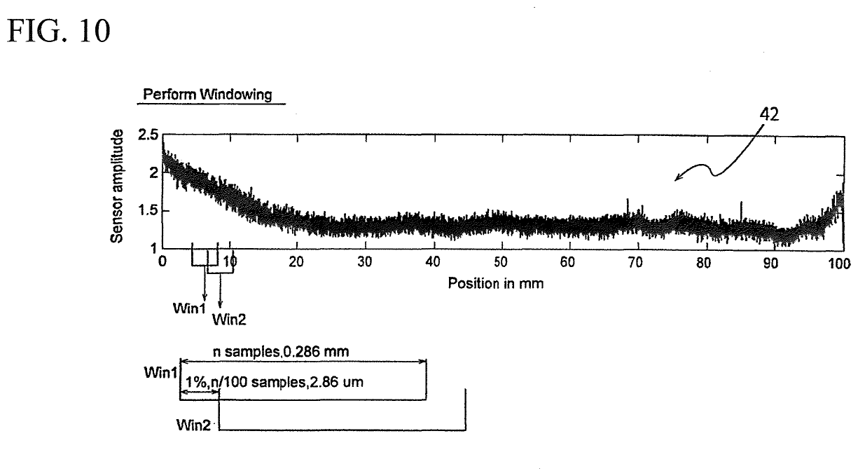

FIG. 10 is a conceptual diagram showing an example of window processing performed by the characteristic vibration analysis section 152 in the machine learning section 150 of the processing apparatus 102 shown in FIG. 8. As shown in FIG. 10, the characteristic vibration analysis section 152 performs window processing for dividing the first vibration signal information 42 acquired by the first sensor 40 into fine time regions (windows) and can extract waveform characteristics for each window.

For example, as shown in FIG. 10, the characteristic vibration analysis section 152 determines the windows with the data of 0.286 mm in the first vibration signal information 42 as being one window, shifting the position by 1% (2.86 μm) in the processing direction (window overlap rate: 99%). Moreover, the characteristic vibration analysis section 152 can extract a waveform shape feature for each window and configure vibration change data using them.

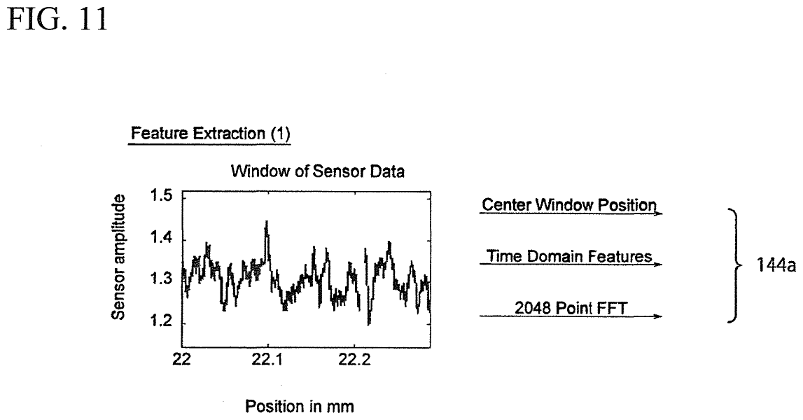

FIG. 11 is a conceptual diagram showing calculation processing for extracting shape features of a waveform from window-processed data as shown in FIG. 10. As shown in FIG. 11, the characteristic vibration analysis section 152 extracts a window position, a maximum value, a minimum value, an average value, an amplitude, a standard deviation, and an output value of fast Fourier transform of the waveform, and the like for each window and can configure a vibration change data 144a with them.

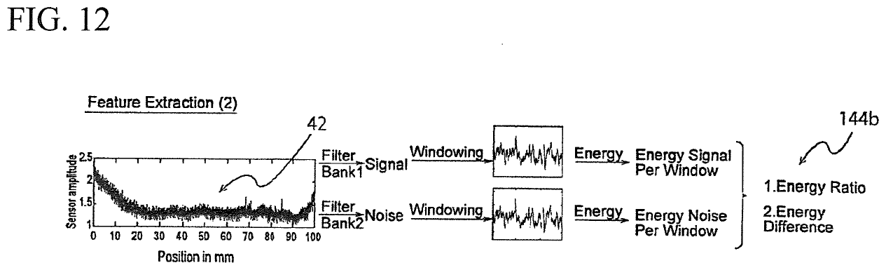

FIG. 12 is a conceptual diagram showing another example of window processing and generation processing of a vibration change data 144b performed by the characteristic vibration analysis section 152 in the machine learning section 150 of the processing apparatus 102 shown in FIG. 8. In the characteristic vibration analysis section 152, as shown in FIG. 12, the vibration change data 144b can be extracted by filtering the first vibration signal information 42 acquired by the first sensor 40 with a predetermined bandwidth to generate a signal component amplified waveform and a noise component amplified waveform, performing window processing on them, and comparing them.

The characteristic vibration analysis section 152 can obtain the signal component amplification waveform by, for example, filtering a frequency that is an integral multiple of the rotational frequency of the rotatable blade 4 with a predetermined bandwidth. Also, the characteristic vibration analysis section 152 can obtain the noise component amplified waveform by filtering a frequency that is ((2n+1)/2) times (n: an integer) the rotational frequency of the rotatable blade 4 with a predetermined bandwidth. Moreover, the characteristic vibration analysis section 152 performs window processing on the signal component amplified waveform and the noise component amplified waveform, calculates the energies of the signal component amplified waveform and the noise component amplified waveform for each window, and configures the vibration change data 144b based on the ratio and difference of the two waveform energies.

In the machine learning section 150 of the processing apparatus 102 shown in FIG. 8, there is no limitation to a calculation method of extracting characteristic vibrations corresponding to processing defects from the primary data and the secondary data of the first sensor 40 or an optimization method using machine learning for a calculation method of extracting characteristic vibrations. For example, the machine learning section 150 can learn the relation between: characteristic values of each window calculated from the detection result of the first sensor 40 (see FIG. 11 and FIG. 12); and existence of generation of chipping (predetermined shape feature) at a position corresponding to the window obtained from image data analysis of the camera 30 or distance between the window and the chipping generation position using methods, such as random forest and deep learning.

In another machine learning section of the processing apparatus 102, the data of the start/stop-point-information extraction section 78 obtained from the detection result of the second sensor 70, etc. can also be used as a feature quantity of vibration in addition to the primary data and the secondary data of the first sensor 40. This makes it possible to further enhance detection accuracy for chipping by comparing the detection result of the first sensor 40 and the detection result of the second sensor as vibration information.

### DESCRIPTION OF THE REFERENCE NUMERICAL

2, 120 . . . processing apparatus
2a . . . preliminary processing section
2b . . . main processing section
4 . . . rotatable blade (processing tool)
6 . . . blade driving shaft (driving shaft)
8 . . . blade supporter
11 . . . tape
12 . . . table
16 . . . X-axis rail (X-axis movement mechanism)
18 . . . fixation base
20 . . . Z-axis rail (Z-axis movement mechanism)
22 . . . Y-axis rail (Y-axis movement mechanism)
30 . . . camera (imaging section)
32 . . . processing-mark image data
34 . . . processing-mark change data
40 . . . first sensor
42 . . . first vibration signal information
44, 144a, 144b . . . vibration change data
45 . . . characteristic vibration
46 . . . threshold value
48 . . . characteristic-vibration-information extraction section
150 . . . machine learning section
152 . . . characteristic vibration analysis section
56 . . . comparison data storage section
57 . . . result storage section
160 . . . image analysis section
70 . . . second sensor
72 . . . second vibration signal information
74 . . . start point information
76 . . . stop point information
78 . . . start/stop-point-information extraction section
90 . . . workpiece

1. A processing apparatus comprising:
a rotatable blade;
a blade driving shaft for driving the rotatable blade;
a table for placing a workpiece to be processed;
a position driving mechanism for changing a relative position between the rotatable blade and the workpiece;
a first sensor for detecting a vibration generated by driving the rotatable blade;
a second sensor for detecting a vibration generated by driving the rotatable blade, the second sensor being different from the first sensor in at least one of detection method, installation position, and measurement frequency;
a start/stop point information extraction section for extracting at least one of a start point information regarding a contact start point where the rotatable blade starts contacting with the workpiece and a stop point information regarding a contact stop point where the rotatable blade stops contacting with the workpiece based on a detection result of the second sensor; and
a characteristic-vibration-information extraction section for extracting a characteristic vibration information regarding a predetermined characteristic vibration generated while processing the workpiece by the rotary blade and for determining a position of the characteristic vibration generated on the workpiece, based on at least one of the start point information and the stop point information and a detection result of the first sensor.

2. The processing apparatus according to claim 1, wherein the second sensor comprises an AE sensor.

3. The processing apparatus according to claim 1, wherein the second sensor is provided on the table.

4. The processing apparatus according to claim 1, wherein the first sensor comprises an acceleration sensor.

5. The processing apparatus according to claim 1, wherein the first sensor is provided on the blade driving shaft or a blade supporter for supporting the blade driving shaft.

6. The processing apparatus according to claim 1, comprising:
an imaging section for capturing an image of a processing mark made by the rotatable blade on the workpiece and acquiring a processing-mark image data; and
a machine learning section for determining the detection result of the first sensor at the time of generation of a predetermined shape feature in the processing mark of the workpiece after processing, using the detection result of the first sensor, the processing-mark image data, and at least one of the start point information and the stop point information and for learning the characteristic vibration information with the detection result of the first sensor at the time of generation of the shape feature as being one of the characteristic vibrations.

7. An electronic component manufacturing method comprising the steps of:
preparing the workpiece;
processing the workpiece by the processing apparatus according to claim 1;
enabling the characteristic-vibration-information extraction section to extract the characteristic vibration and to determine a position of the characteristic vibration generated on the workpiece; and
removing a portion of the workpiece after processing including a position corresponding to the characteristic vibration.

8. An electronic component manufacturing method comprising the steps of:
preparing a preliminary workpiece corresponding to the workpiece used for machine learning;
processing the preliminary workpiece by the processing apparatus according to claim 6;
enabling the machine learning section to determine the detection result of the first sensor at the time of generation of a predetermined shape feature in a processing mark of the preliminary workpiece after processing and to learn the characteristic vibration information with the detection result of the first sensor at the time of generation of the shape feature as being one of the characteristic vibrations;
preparing a workpiece different from the preliminary workpiece;
processing the workpiece by the processing apparatus;
enabling the characteristic-vibration-information extraction section to extract the characteristic vibrations and to determine a position of the characteristic vibrations generated on the workpiece; and
removing a portion of the workpiece after processing including a position corresponding to the characteristic vibrations.
